(19) United States
(12) Patent Application Publication
(10) Pub. No.: US 2019/0246676 A1
(43) Pub. Date: Aug. 15, 2019

(54) GLUTEN-FREE RESISTANT STARCH AND METHOD OF MAKING THE SAME

(71) Applicant: Manildra Milling Corporation, Leawood, KS (US)

(72) Inventors: Neal Dev Bassi, Overland Park, KS (US); Sukh Dev Bassi, Overland Park, KS (US); Luke Dean Stockstell, Olathe, KS (US); Brook Ashley Carson, Prairie Village, KS (US)

(21) Appl. No.: 16/331,844

(22) PCT Filed: Oct. 27, 2016
(86) PCT No.: PCT/US2016/059117

§ 371 Date: Mar. 8, 2019

Related U.S. Application Data
(60) Provisional application No. 62/404,984, filed on Oct. 6, 2016.

(51) Int. Cl. A23L 29/219; A23L 33/21; A23L 7/104; A23J 3/34

(52) U.S. Cl. CPC A23L 29/219; A23L 33/21; A23L 7/107; A23V 2300/28; A23V 2002/00; A23V 2250/5118; A23V 2300/24; A23J 3/346

(57) ABSTRACT

Gluten-free starch with increased total dietary fiber and methods of producing such starch are disclosed. More particularly, the starch contains less than 20 parts per million of gluten and at least 85% total dietary fiber. In some embodiments, the starch is derived from a source naturally containing gluten; in others, the starch is derived from a source which is naturally gluten-free but potentially contaminated or commingled with a gluten source. A method of making gluten-free resistant starch is disclosed, the method comprising: providing an initial starch containing a gluten protein; mixing the initial starch with water to produce an initial starch slurry; heating the starch slurry; adding an agent to dissolve or degrade the gluten protein to yield a slurry containing starch and degraded gluten protein; mixing sodium sulfate and STMP with the starch slurry; raising pH of the slurry to about pH of about 11-13; increasing heat to 115° F. while maintaining pH 11-13 for 1-24 hours; reducing pH to 6 by addition of acid and washing and separating starch from the slurry.

### CROSS REFERENCE TO RELATED APPLICATIONS

This application claims priority to U.S. Provisional Patent Application Ser. No. 62/404,984, filed Oct. 6, 2016, entitled “Gluten-Free Resistant Starch and Method of Making the Same,” the entire contents of which is hereby incorporated by reference herein.

### FIELD

This disclosure is broadly concerned with gluten-free starch with increased total dietary fiber and methods of producing such starch. More particularly, the present invention is concerned with starch containing less than 20 parts per million of gluten and at least 85% total dietary fiber, and methods of making such a starch. In some embodiments, the starch is derived from a source naturally containing gluten; in others, the starch is derived from a source which is naturally gluten-free but potentially contaminated or commingled with a gluten source.

### BACKGROUND

Awareness of intolerance to gluten has increased in recent years. International and American standards for “gluten-free” labeling have been promulgated, in recognition of the need for products that meet those standards. A gluten-free diet, however, also raises some new concerns, or potentially exacerbates existing concerns, such as the need for more fiber in the diet. Gluten-containing products such as bread and pasta provide a source of fiber, which is particularly lacking in the American diet. Thus, there is a strong need for re-introducing fiber into the diets of those that are gluten-free.

White rice flour, corn starch, potato starch, and tapioca starch have been and continue to be the staples for gluten-free baking and are found in most gluten-free specialty products. Only white rice flour comes close to the fiber content found in enriched white (wheat) flour, and none come close to the fiber content found in whole wheat flour. Dietary fiber is the type of fiber that passes through the small intestine largely undigested and enters the large intestine (i.e., colon) where it is thought to have beneficial health benefits, including providing more surface area for beneficial bacteria, aiding and expediting formation of solid stools, reducing likelihood of polyps, etc.

The Codex Alimentarius Commission (the “Codex”), was developed by the Food and Agricultural Organization of the United Nations (FAO) and the World Health Organization (WHO) to develop harmonized international food standards, which protect consumer health and promote fair practices in food trade. The Codex defines “gluten” as a protein fraction of wheat, rye, barley, or oats or their crossbred varieties and derivatives thereof, to which some persons are intolerant and that is insoluble in water and 0.5 M NaCl. “Gluten-free” food is defined as dietary food consisting of or made from one or more ingredients which do not contain wheat (i.e., all Triticum species, such as durum wheat, kamut, spelt), rye, barley, oats, or their crossbred varieties, and which contain less than 20 mg/kg (or 20 parts per million (ppm) or 0.0020%) in total of gluten, based on the food as sold or distributed to the consumer, and/or consisting of one or more ingredients from wheat (i.e., all Triticum species), rye, barley, oats, or their crossbred varieties, which have been specially processed to remove gluten, and the gluten level is less than 20 mg/kg in total, based on the food as sold or distributed to the consumer.

The U.S. Food and Drug Administration (FDA) similarly defines “gluten-free” to mean less than 20 parts per million (ppm) of gluten. The FDA also allows manufacturers to label a food as “gluten-free” if it inherently does not contain gluten and if the food does not contain an ingredient that is any type of wheat, rye, barley, or crossbreeds of these grains, or an ingredient derived from these grains that has been processed to remove gluten, if it results in the food containing less than 20 ppm of gluten.

The popularity of gluten-free foods is increasing because of a health halo effect and because of millions of people afflicted with celiac disease, a hereditary, chronic inflammatory disorder of the small intestine triggered by the ingestion of gluten occurring in wheat, rye, barley, and crossbreeds of these grains. Celiac disease results in inflammation, villous atrophy, cryptic hyperplasia, poor absorption of nutrients and, if left untreated, increases the risk of other disorders such as anemia, osteoporosis, short stature, infertility, neurological problems, cancer, and other autoimmune disorders. A lifelong adherence to a gluten-free diet is considered the safest and most effective way to treat and manage the disease. People suffering from gluten intolerance or gluten sensitivity (i.e., those afflicted with Crohn's disease, ulcerative colitis, irritable bowel syndrome, or dermatitis herpetiformis) are also prescribed a gluten-free diet. In addition, some people experience an allergy or IgE-mediated response to gluten.

Wheat starch and wheat gluten are important ingredients in the food industry. Bakery products remain the predominant application for wheat starch because its properties closely match those of endogenous starch in wheat flour. The multi-functionality of wheat starch in yeast-leavened bread is summarized as follows: It dilutes the wheat gluten to an appropriate consistency, provides maltose for fermentation through the action of amylase, provides a surface for strong bonding with wheat gluten, provides flexibility for loaf expansion during partial gelatinization while baking, sets the loaf structure by providing a rigid network to prevent the loaf collapsing when cooling, gives structural and textural properties to the baked product, holds or retains water by acting as a temperature-triggered water sink, and contributes to staling. Fractionation and reconstitution studies revealed that rye and barley starches can substitute for wheat starch in producing bread of satisfactory volume. Starches from corn, sorghum, oat, rice, and potato produced inferior bread. Most gluten-free foods, however, are not formulated with wheat starch because of the perceived presence of gluten. People who are intolerant to gluten typically avoid anything with “wheat” in its name. Thus, there is a need to commercially develop gluten-free wheat starch for safe and widespread use in the production of gluten-free foods.

Thus, the gluten-free community would welcome a gluten-free starch with improved fiber content. Such starches and methods of making them are described herein.

### SUMMARY

Some embodiments provide a composition comprising a chemically-modified starch having at least 85% total dietary fiber; and less than 20 ppm gluten proteins. In some embodiments, the starch is derived from a source naturally containing gluten or a source potentially contaminated with gluten. In some embodiments, the chemically-modified starch is selected from one or more of wheat starch, rye starch, barley starch, and triticale starch. In some embodiments, the chemically-modified starch is at least 15% resistant to α-amylase digestion. In some embodiments, at least 95% of the composition is the chemically modified starch. In some embodiments, the composition has less than 100 ppm phosphates.

Some embodiments provide a method of making gluten-free resistant starch, the method comprising providing an initial starch containing a gluten protein; mixing the initial starch with water to produce an initial starch slurry; heating the starch slurry; adding an agent to dissolve or degrade the gluten protein to yield a slurry containing starch and degraded gluten protein; mixing sodium sulfate and STMP, with the starch slurry; raising pH of the slurry to about pH of about 11-13; increasing heat to 115° F. while maintaining pH 11-13 for 1-20 hours; reducing pH to 6 by addition of acid; washing and separating starch from the slurry to yield a purified starch having less than 20 ppm gluten protein, at least 85% total dietary fiber.

In some embodiments, the agent to dissolve or degrade the gluten protein is selected from the group consisting of acids, bases, alcohols, surfactants, proteases, chaotropic agents, reducing agents, and combinations thereof

In some embodiments, the agent comprises an acid selected from the group consisting of mineral acids, organic acids and salts thereof, and combinations thereof.

In some embodiments, the agent is Hydrochloric Acid.

In some embodiments, the agent comprises a base selected from the group consisting of Sodium Hydroxides, potassium hydroxides, calcium hydroxides, ammonium hydroxides, and magnesium hydroxides, and alkaline salts, and combinations thereof.

In some embodiments, the base is Sodium Hydroxide.

In some embodiments, the initial starch containing the gluten protein comprises gluten protein at about 470 ppm or less.

In some embodiments, the agent comprises an alcohol selected from the group consisting of C2-C10 alcohols and combinations thereof.

In some embodiments, the agent comprises a surfactant selected from the group consisting of anionic surfactants, cationic surfactants, nonionic surfactants, and zwitterionic surfactants, and combinations thereof.

In some embodiments, the agent comprises a protease selected from the group consisting of endo-proteases, exo-proteases, and combinations thereof.

In some embodiments, the agent comprises Alcalase.

In some embodiments, the initial starch containing the gluten protein comprises 470 ppm gluten protein or less.

In some embodiments, the agent comprises the protease Alcalase, and the adding step includes mixing Alcalase with the starch slurry at a pH of about 5.5 to about 6.5.

Some embodiments provide a method of making a gluten-free starch with increased total dietary fiber content, the method comprising mixing a gluten-free starch with 5-9% sodium sulfate and 6-10% STMP, by weight of the starch (in some embodiments about 8% sodium sulfate and about 9% STMP are used); adding caustic solution to achieve pH 11-13; increasing heat to 115° F. while maintaining pH 11-13 for 1-20 hours; reducing pH to 6 by addition of acid; washing and separating chemically modified starch from solution to yield a purified starch having less than 20 ppm gluten protein, and at least 85% total dietary fiber.

### BRIEF DESCRIPTION OF THE DRAWINGS

FIG. 1 is a flow chart depicting an exemplary process flow in accordance with some methods of making a gluten-free resistant starch disclosed herein.

FIG. 2 is a flow chart depicting an exemplary process flow in accordance with some methods of making a gluten-free resistant starch disclosed herein.

### DETAILED DESCRIPTION

Starches of various varieties are common in gluten-free products. Proposed herein are gluten-free starches that have increased total dietary fiber. Thus, in a single starch product, both gluten-free status and increased dietary fiber can be achieved. It should be understood that organic starch sources may be used in addition to traditional sources.

To achieve the desired characteristics, the gluten content of the starch is reduced and the reduced-gluten starch is chemically modified to be resistant to α-amylase. The chemically modified starches find particular utility as a food additive, particularly in yeast- or chemically-leavened, baked or fried food such as breads and crackers. In this context, the starches of the invention serve as a gluten-free, low calorie source of dietary fiber and resistant starch. Generally, the modified starches would be used in food products of up to a level from about 25% by weight, and more preferably up to about 15% by weight. It is conceivable they could be used up to 35% by weight or more.

Disclosed herein are methods of converting an initial starch having a gluten protein (either naturally or as a contaminant) into a gluten-free (i.e., less than 20 ppm gluten) starch having total dietary fiber of at least 85%.

U.S. patent application Ser. No. 15/193,622, entitled Gluten-free Starch and Methods of Producing the Same, filed contemporaneously herewith, and its provisional application, U.S. Provisional Patent Application Ser. No. 62/184,316, filed Jun. 25, 2015, each of which is incorporated by reference in its entirety, teach methods of making a gluten-free starch meeting the Codex and FDA standards of less than 20 ppm gluten. Such methods are adapted and modified for use along with methods of increasing the total dietary fiber in the starch to yield the gluten-free high total dietary fiber starches described herein.

U.S. Pat. No. 5,855,946, incorporated herein by reference in its entirety, teaches methods of producing resistant starches. Resistant starches are resistant to α-amylase, and like dietary fiber, pass through the small intestine largely undigested. The methods similar to those disclosed in U.S. Pat. No. 5,855,946 are adapted and modified for use along with methods of creating gluten-free starch. Other methods of preparing a resistant starch may also be employed.

In accordance with the methods herein, gluten proteins are solubilized from a starch and the dissolved proteins extracted to produce a gluten-free or relatively gluten-free starch slurry which may then be further treated to make the starch resistant to α-amylase. The gluten content and resistance may be independently confirmed by lab analysis.

In particular, a starch slurry may be treated with one or more agents, such as acids, alkalis, alcohols, surfactants, proteases, chaotropic agents, reducing agents, and/or combinations of these agents or other agents to dissolve or otherwise degrade residual gluten proteins. At this point, the slurry contains the starch and the dissolved/degraded gluten proteins. This slurry (from which the degraded gluten proteins may optionally be removed) may then be treated to render the starch a resistant starch. To achieve resistant status, the slurry is mixed with a mixture of sodium sulfate and sodium trimetaphosphate (STMP), and tripolyphosphate (TPP). The slurry is adjusted, slowly, with a caustic solution, such as a 2.5M solution of NaOH to reach pH of about 11 to about 13. The mixture is then heated to about 115° F. while maintaining the pH. The mixture is allowed to react for about 12 hours maintaining temperature and pH. After sufficient reaction, the pH of the mixture is reduced to about a pH of 6 through the addition of acid, such as sulfuric acid. Preferably, this is done slowly with about a 2.4M acid solution. Once the mixture is acidified, it can be washed and decanted to yield the desired product. Experience reveals that thorough washing, preferably at least three times, is important for removing undesirable salts produced during the process.

The resultant product is a starch that is both gluten-free (i.e., <20 ppm gluten proteins) and has a total dietary fiber of at least 85% (i.e., is a resistant starch).

In some methods, the starch slurry may be washed and separated before taking steps to make the starch resistant, but this is not necessary.

In one embodiment, a method of processing a starch from a plant belonging to the tribe Triticeae (e.g., wheat, rye, barley, triticale) and containing a gluten protein to produce a gluten-free (i.e., less than 20 ppm of gluten) starch may proceed substantially as follows. A slurry of the unpurified starch containing the starch and the gluten protein may be obtained. In certain embodiments, the starch slurry has a specific gravity of from about 18° to about 25° Baumé, from about 19° to about 23° Baumé, from about 20° to about 22° Baumé, or about 21° Baumé. In certain embodiments, the starch slurry comprises from about 30% to about 50% by weight, from about 33% to about 45% by weight, or from about 35% to about 42% by weight starch solids.

The slurry of the starch may be treated to dissolve or otherwise degrade the gluten protein. Treating the slurry of the starch may include adding an agent thereto. The agent can be an acid, a base, an alcohol, a surfactant, a protease, a chaotropic agent, a reducing agent, or combinations thereof. Exemplary acids that may be used with the present invention include mineral acids (e.g., Hydrochloric Acid, sulfuric acid, phosphoric acid, nitric acid, and boric acid), organic acids (e.g., formic acid, acetic acid, propionic acid, butyric acid, lactic acid, malic acid, citric acid, tartaric acid, and succinic acid), and salts thereof. In certain embodiments, the acid should be added to the starch slurry so as to lower the pH of the slurry to less than 5.0, less than 4.5, or less than 4. In other embodiments, the acid may be added to the starch slurry so as to provide a pH of from about 1 to about 5, from about 1.5 to about 4, or from about 2 to about 3.5.

Common alkaline chemicals that may be used with the present methods are hydroxides of ammonium, sodium, potassium, calcium, and magnesium, and alkaline salts (e.g., sodium carbonate and potassium carbonate). In embodiments in which the agent comprises a basic material, the agent may be added to the starch slurry in an amount so as to raise the pH of the starch slurry to at least 9, at least 10, or at least 11. In other embodiments, the basic agent may be added to the starch slurry so as to provide a pH of from about 9 to about 13, from about 9.5 to about 12.5, from about 10 to about 12, or from about 10.5 to about 11.5.

Exemplary alcohols that may be used with the present invention include C2-C10 alcohols, such as ethyl alcohol, propyl alcohol, and isopropyl alcohol. In certain embodiments, the alcohol may be added to the starch slurry so as to provide an alcohol level within the starch slurry of from about 40% to about 80% by weight, from about 45% to about 75% by weight, or from about 50% to about 70% by weight based upon the amount of starch solids contained in the slurry.

Exemplary surfactants that may be used with the present invention include anionic, cationic, nonionic, and zwitterionic surfactants. In certain embodiments, the surfactant is an anionic surfactant such as sodium lauryl sulfate (or Sodium Dodecyl Sulfate). In embodiments in which a surfactant is added to the starch slurry, it is added so as to provide a surfactant level within the starch slurry of from about 0.01% to about 5% by weight, from about 0.1% to about 2.5% by weight, or from about 0.25% to about 1% by weight, based upon the amount of starch solids contained in the slurry.

Chaotropic agents are molecules in a water solution that can disrupt the hydrogen bonding network between water molecules. This has an effect in the stability of the native state of other molecules in solution, such as proteins, by weakening the hydrophobic effect.

For example, a chaotropic agent reduces the amount of order in the structure of a protein formed by water molecules, both in the bulk and the hydration shells around hydrophobic amino acids, and may cause its denaturation. Exemplary chaotropic agents that may be used with the present invention include Urea, guanidine hydrochloride, dicyandiamide, and thiourea, and combinations thereof. In embodiments in which a chaotropic agent is added to the starch slurry, it is added so as to provide a chaotropic agent level within the starch slurry of from about 0.01% to about 5% by weight, from about 0.1% to about 2.5% by weight, or from about 0.25% to about 1% by weight, based upon the amount of starch solids contained in the slurry.

Exemplary proteases that may be used with the present methods include endoproteases, exoproteases, or mixtures of endo/exoproteases. In particular embodiments, the protease may be Alcalase or a proline specific protease such as MaxiPro PSP, from DSM Food Specialties. Proteases generally are capable of solubilizing wheat proteins by virtue of their ability to hydrolyze the proteins into low-molecular weight, water soluble peptides or oligopeptides and even down to amino acids. In embodiments in which proteases are added to the starch slurry, it is added so as to provide a protease level within the starch slurry of from about 0.001% to about 1% by weight, from about 0.005% to about 0.5% by weight, or from about 0.01% to about 0.1% by weight, based upon the amount of starch solids contained in the slurry.

Exemplary reducing agents that may be used with the present methods include sodium metabisulfite, beta-mercaptoethanol, L-cysteine, and glutathione. Reducing agents generally cleave disulfide bonds in proteins to aid in solubilization of gluten proteins. In embodiments in which reducing agents are added to the starch slurry, they are added so as to provide a reducing agent level within the starch slurry of from about 0.01% to about 3% by weight, from about 0.025% to about 1% by weight, or from about 0.05% to about 0.5% by weight, based upon the amount of starch solids contained in the slurry.

Treating the starch slurry may also include heating the starch slurry to a temperature that is greater than room or ambient temperature and less than the boiling point of the slurry. In certain embodiments, this involves heating the starch slurry to a temperature from about 80° F. to about 120° F., from about 85° F. to about 115° F., or from about 90° F. to about 110° F. The slurry may also be stirred or otherwise agitated during the treating step for a period of time from about 10 minutes to about 2 hours, from about 30 minutes to about 1.5 hours, or about 1 hour.

Once the degradation reactions have occurred, the slurry may then be treated to produce the resistant starch. The removal of the degraded gluten protein may optionally be performed at this time.

The resultant starch slurry is reacted in the presence of water and with a cross-linking agent under conditions of pH and temperature to yield a modified starch that is resistant to α-amylase. The cross-linker may be STMP, TPP, or mixtures thereof. Preferred reaction conditions include a basic pH (preferably from about 10-13 and more preferably from about 11-12) and a reaction temperature of from about 25° C. to about 70° C. and more preferably from about 30° C. to about 50° C. The reaction need be carried out only for a sufficient time to provide the requisite degree of α-amylase digestion resistance, and this would normally be for a period of from about ⅙ to 24 hour. Sodium sulfate or sodium chloride may also be added to the slurry. The presence of one of these salts serves to retard gel formation during the reaction and to accelerate the reaction by increasing the base adsorbed by the starch granules.

Below is an exemplary method for making a starch that is gluten-free and contains at least 85% total dietary fiber.

### EXAMPLE 1

### Organic, Native Gluten-Free Resistance Starch

Trial Procedure—Alcalase Method-pH 11

I. First Step: making gluten-free starch:

1. Weigh 396 grams of Org. Wheat Starch HORG040716 in a 4000 mL Beaker.

2. Add 604 grams of water (104° F.) to the beaker and mix the slurry.

3. Place Beaker in a water bath (104° F. maintained) on top of a stir hot plate and turn on the stirring creating a vortex to achieve an entire mix.

4. Add 9.4 ml of Alcalase solution (0.6 grams of Alcalase mixed with 100 ml of water) (0.0165% addition).

5. Stir the mixture for 1 hours at 104° F. Mixing RPM: 700 rpm.

II. Second Step: Render gluten-free starch resistant.

6. ˜Add teaspoon full of TPP (Tri PolyPhosphate). NOTE: Not necessary for lab trial—did not do in lab.

7. Mix together, 28.8 grams (8% based on weight of starch) of sodium sulfate and 32.4 grams of STMP (9% based on weight of starch). Add sodium sulfate/STMP mixture to the slurry slowly after ramping up the mixing. Mixer RPM: 750.

8. Add 10% (2.5 M) caustic solution to pH 11-13 very slowly with adequate mixing -pH 11.57 adding 62.8 g NaoH over 32 minutes.

9. Heat to 115° F.

10. Reaction time: 12 hours at 115° F., while maintaining 11.0 pH-10.91 pH after 15 hours—27.9 g NaOH overnight.

11. Drop pH down to 6 by using sulfuric acid (add slowly and do not use a very strong concentration 2.4 M) 115.2 g to get to 5.99.

III. Third step: washing

12. Wash and decant three times—Rehydrate starch in each bottle each time with 100 grams of water. Wash very well, washing is critical in ridding the product of the produced salts.

| | | | | | Gluten |
|---|---|---|---|---|---|
| pH | Ash | Viscosity | TDF | Phosphates | ppm |
| 6.67 | 0.193 | 0 | 97% | Less than | BLQ* |
| | | | | 100 ppm | |

The resultant product was tested by the University of Nebraska Lincoln Institute of agriculture and natural resources, food allergy research and resource program. The lab used the R-Biopharm RIDASCREEN Gliadin competitive assay (SOP-BGP-421) which has a BLQ of 10 ppm. As shown in the table above, gluten content is below the level of quantification (“BLQ”), and thus satisfies the CODEX and FDA threshold of 20 ppm to qualify for gluten-free labeling.

The sample was also tested for total dietary fiber content at Medallion Labs. Total dietary fiber was tested in accordance with AOAC method 991.43 and for phosphates. As shown in the table above, total dietary fiber was 97% and phosphates were less than 100 ppm.

Thus, a starch being both gluten-free and high in total dietary fiber has been made. Such a product addresses several needs in the market place, without a degradation in the functional properties of the starch.

Although this description is directly mainly toward wheat starch sources, other starch sources may be used as well. By employing the methods described herein, a starch, regardless of source, can be made and confirmed to be gluten-free and high in total dietary fiber.

As noted above, there are several methods useful for the reduction or removal of gluten from the source starch. A few examples follow:

In a first implementation, a wheat starch slurry (approximately 15,000 gallons, 21 Baumé, 100° F.) may be transferred to a tank equipped with an agitator. An approximately 10% Sodium Hydroxide solution may be slowly added to the slurry to adjust the pH to approximately 11.0. The slurry may then be allowed to stir for approximately one hour to solubilize residual gluten proteins. The slurry optionally may then be washed with fresh water and centrifuged to remove the solubilized proteins and residual Sodium Hydroxide. This slurry may then be subjected to the steps below to create the resistant starch.

In a second implementation, a wheat starch slurry (approximately 15,000 gallons, 21 Baumé, 100° F.) may be transferred to a tank equipped with an agitator. An approximately 10% Hydrochloric Acid solution may be slowly added to the slurry to adjust the pH to approximately 3.5. The slurry may then be allowed to stir for approximately one hour to solubilize any residual gluten proteins. This slurry may then be subjected to the steps below to create the resistant starch.

In a third implementation, a wheat starch slurry (approximately 15,000 gallons, 21 Baumé, 100° F.) may be transferred to a tank equipped with an agitator. Alcalase (approximately 0.02% based on starch solids), which is a protease, may be slowly added to the slurry. The slurry may then be allowed to stir for approximately one hour at approximately pH 5-6 to hydrolyze any residual gluten proteins. This slurry may then be subjected to the steps below to create the resistant starch.

In a fourth implementation, a wheat starch slurry (approximately 15,000 gallons, 21 Baumé, 100° F.) may be transferred to a tank equipped with an agitator. MaxiPro PSP (approximately 0.02% based on starch solids), which is a proline-specific protease, may be slowly added to the slurry. The slurry may then be allowed to stir for approximately one hour at approximately pH 5-6 to hydrolyze any residual gluten proteins. This slurry may then be subjected to the steps below to create the resistant starch.

In a fifth implementation, a wheat starch slurry (approximately 15,000 gallons, 21 Baumé, 100° F.) may be transferred to a tank equipped with an agitator. Sodium lauryl sulfate (approximately 0.5% based on starch solids), which is a surfactant, may be slowly added to the slurry. The slurry may then be allowed to stir for approximately one hour at approximately pH 5-7 to solubilize any residual gluten proteins. This slurry may then be subjected to the steps below to create the resistant starch.

In a sixth implementation, a wheat starch slurry (approximately 15,000 gallons, 21 Baumé, 100° F.) may be transferred to a tank equipped with an agitator. Urea (approximately 0.5% based on starch solids), which is a chaotropic agent, may be slowly added to the slurry. The slurry may then be allowed to stir for approximately one hour at approximately pH 5-7 to solubilize any residual gluten proteins. This slurry may then be subjected to the steps below to create the resistant starch.

In a seventh implementation, a wheat starch slurry (approximately 15,000 gallons, 21 Baumé, 100° F.) may be transferred to a tank equipped with an agitator. Sodium metabisulfite (approximately 0.1% based on starch solids), which is a reducing agent, may be slowly added to the slurry. The slurry may then be allowed to stir for approximately one hour at approximately pH 5-7 to solubilize any residual gluten proteins. This slurry may then be subjected to the steps below to create the resistant starch.

To verify some of the above described implementations, lab trials were conducted by the assignee of this application, Manildra Milling Corporation. For purposes of evaluating gluten content, the below examples were washed to remove the degraded gluten and dried.

Various wheat starches, described as native (U.S. origin), organic (U.S. origin), and starch from Australian flour were used as exemplary starch sources. All starches were produced by Manildra at its various facilities. The starches from native and organic flours were produced in the United States, while the Australian was produced in that country. Due to differences in the raw wheat sources and the starch separation processes, the gluten protein content of the starch varied from one source to another. Each of these starches was combined with different chemicals or enzymes to assess the ability to achieve the less than 20 ppm of gluten required by the Codex and the FDA to be considered gluten-free. Australian and Organic Wheat Starches have a lower ppm of gluten to use as a starting material, which is advantageous, but not always necessary, as will be shown below.

As discussed above, chemical or enzyme treatments, at various levels, were identified for use in treating starch. The following specific agents were tested:

| | |
|---|---|
| Protease enzymes | Alcalase |
| Acids | Sodium Hydroxide |
| Alkalis | Hydrochloric Acid |
| | Sodium Metabisulfate |
| Surfactants | Sodium Dodecyl Sulfate |
| Chaotropic Agents | Urea |

Through a series of laboratory experiments these agents were employed at various levels to attempt to achieve the less than 20 ppm gluten protein standard. Outside testing was performed on the starch for gluten ppm by FARRP Labs-University of Nebraska-Lincoln-Food Innovation Center, Lincoln, Nebr., using the R-Biopharm RIDASCREEN. All other testing, e.g., viscosity, pH, and ash, were performed in house at Manildra.

The lab trials were done in three steps:

Step 1 included lab scale trials with original dosages of the chemicals or enzymes. The success of these tests led to Step 2.

Step 2 included laboratory scale trials including various changes to agent levels and washing methods. These levels were increased or decreased based upon gluten protein ppm results from the first trial. In this phase, all trials were run with Organic Wheat Starch as the initial starch containing wheat gluten protein.

Step 3 laboratory scale trials were performed with more changes to the chemicals and enzymes, and for five of the tests the base material was changed from Organic Wheat Starch to Australian Wheat Starch, which has even lower initial gluten levels.

Below, each gluten reduction procedure is outlined for all three trials, starting with the testing of the starting materials to establish initial gluten protein levels.

Starting Material Analysis

All tests ran for the three trials were run with 1 of 3 starting materials, Organic Wheat Starch HORG 080315, Native Wheat Starch H100215, or Australian Wheat Starch N091815. As noted above, each of these is a wheat starch product prepared by and available from Manildra. Each starting material was tested for gluten ppm, viscosity, and residual enzyme activity where necessary. The results are as follows:

| Starch Description | Gluten ppm (FARRP Labs) | Viscosity B.U. |
|---|---|---|
| Organic | 470 ppm | 351 B.U. |
| HORG080315 | | |
| Native | 600 ppm | 343 B.U. |
| H100215 | | |
| Australian | 36 ppm | 329 B.U. |
| N091815 | | |

Initial gluten concentration and viscosity emerged as important guides to determine success in making the product gluten-free without damaging the functionality of the starch. Maintaining starch functionality is vital to the final starch product.

The following data and explanations are divided out for each of the 7 different chemicals/enzymes that were employed, including any modification.

The Protease Method

The first trial with Alcalase (a protease) was performed using both the native wheat starch (60 grams) and Organic Wheat Starch (60 grams) slurried with 90 grams of water, to be combined with 0.022% of Alcalase, and was allowed to react for 2 hours under stirring at 104° F. at 5.5-6.5 pH. This treated slurry was then washed three times with water and centrifuged, to mimic plant conditions, to rid the sample of enzyme and the destroyed gluten.

Below are the gluten results and chemical usage data:

| | FARRP | | |
|---|---|---|---|
| Initial Starch | Results-Gluten | | Residual |
| Product | ppm | Chemical Usage | Enzyme Activity |
| HORG080315- | BLQ* | 0.022% Alcalase | None |
| organic starch | | | |
| H100215-native | BLQ* | 0.022% Alcalase | None |
| starch | | | |

It can be seen readily that 0.022% Alcalase is sufficient to reduce gluten protein levels below the 20 ppm level in initial starches having gluten present at up to at least 600 ppm.

Trial 2 followed trial 1 with the following modifications:

1. Normal method (0.022% Alcalase) but with 2 times the starch, 120 grams.

2. Normal method with only 2 washings instead of 3 (to determine the ability of getting rid of the enzyme with less washing) with 120 grams of starch.

3. 50% reduction of Alcalase (0.011% Alcalase) with 120 grams of starch.

4. All methods were conducted on Organic Wheat Starch (initial gluten protein 470 ppm).

The results were as follows:

| | FARRP | | | |
|---|---|---|---|---|
| Initial Starch | Results- | | | Enzyme |
| Product | Gluten ppm | Chemical Usage | Viscosity | Activity |
| HORG080315- | BLQ* | 0.022% Alcalase | 415 B.U. | None |
| 120 g-of Organic | | | | |
| starch | | | | |
| HORG080315- | BLQ* | 0.022% Alcalase | 332 B.U. | None |
| 120 g-of Organic | | | | |
| starch | | | | |
| HORG080315- | BLQ* = | 0.011% Alcalase | 370 B.U. | None |
| 120 g-of Organic | | | | |
| starch | | | | |

Here, it is clear that even when increasing the amount of initial product and reducing the amount of protease, gluten protein content is successfully reduced below the 20 ppm standard.

Trial 3 employed further modifications:

1. Continue to use Organic Wheat Starch HORG080315.

2. Reduce the level of Alcalase in samples to 25% of original amount and 10% of original amount.

3. Continue using 120 grams of wheat starch.

4. Run previous successful tests in duplicates.

Data obtained after testing with above modifications:

| Initial Starch | FARRP Results- | | |
|---|---|---|---|
| Product | Gluten ppm | Chemical Usage | Viscosity |
| HORG080315- | 20 ppm | 0.0055% Alcalase | 392 B.U. |
| 120 g-Organic | | | |
| Wheat Starch | | | |
| HORG080315- | 46 ppm | 0.0055% Alcalase | 372 B.U. |
| 120 g-Organic | | | |
| Wheat Starch | | | |
| HORG080315- | 7 ppm | 0.0022% Alcalase | 243 B.U. |
| 120 g-Organic | | | |
| Wheat Starch | | | |
| HORG080315- | 12 ppm | 0.0022% Alcalase | 274 B.U. |
| 120 g-Organic | | | |
| Wheat Starch | | | |

The Protease treatment, particularly when using Alcalase, works best when using 0.0022%-0.022% Alcalase, based on dried starch weight, and washed three times to ensure that the enzyme and protein is washed out of the starch, using a starch with an initial ppm of 470 or less. In some embodiments, Alcalase may be introduced at about 0.001% to about 0.05% by weight, or about 0.002% to about 0.02% by weight.

Alkali Method (Sodium Hydroxide (NaOH))

The first trial with Sodium Hydroxide was performed, on both the native wheat starch (60 grams) and Organic Wheat Starch (60 grams) slurried with 90 grams of water, to be combined with 15 grams of 0.5 M NaOH and allowed to react for 1 hour under stirring at 104° F., washed, then treated with 15 grams of 0.5 M NaOH again. Then, again, allowed to react for 1 hour under stirring at 104° F., before adjusting the pH to 5.5 using 0.5 M Hydrochloric Acid. This product was then washed three times, to mimic plant conditions, to rid the sample of the agent and the gluten. Below are the gluten results and chemical usage data:

| | FARRP | |
|---|---|---|
| Initial Starch Product | Results-Gluten ppm | Chemical Usage |
| HORG080315-60 g- | 13 ppm | 33.7 g of 0.5M NaOH and |
| Organic Wheat Starch | | 31.7 g 0.5M HCl |
| H100215-60 g Native | 6 ppm | 33.7 g of 0.5M NaOH and |
| Wheat Starch | | 31.7 g of 0.5M HCl |

The results support that starch containing gluten at least as high as 600 ppm can be successfully treated with Sodium Hydroxide to achieve the desired gluten-free levels.

Trial 2 was performed with the following modifications:

1. Normal method but with 2 times the starch, 120 grams.

2. 50% reduction of Sodium Hydroxide with 120 grams of starch.

3. All samples will be ran on Organic Wheat Starch.

The results were as follows:

| Initial Starch | FARRP Results- | | |
|---|---|---|---|
| Product | Gluten ppm | Chemical Usage | Viscosity |
| HORG080315- | 13 ppm | 67.41 g of NaOH and | 389 B.U. |
| 120 g-Organic | | 63.72 g of HCl | |
| Wheat Starch | | | |
| HORG080315- | 24 ppm | 33.7 g of NaOH and | 410 B.U. |
| 120 g-Organic | | 32.02 g of HCl | |
| Wheat Starch | | | |

Trial 3 for Sodium Hydroxide treated starch were conducted with the following changes to procedure:

1. Continue to use Organic Wheat Starch HORG080315.

2. Reduce the level of Sodium Hydroxide to 75% and 50%.

3. Continue using 120 grams of wheat starch.

4. Run tests in duplicates.

The procedures otherwise remained the same as the original.

| | FARRP | | |
|---|---|---|---|
| | Results- | | |
| Initial Starch Product | Gluten ppm | Chemical Usage | Viscosity |
| HORG080315-120 g- | 8 ppm | 50.5 g of 0.5M NaOH | 322 B.U. |
| Organic Wheat Starch | | 36.2 g of 0.5M HCl | |
| HORG080315-120 g- | 5 ppm | 50.5 g of 0.5M NaOH | 344 B.U. |
| Organic Wheat Starch | | 35.0 g of 0.5M HCl | |
| HORG080315-120 g- | 44 ppm | 33.7 g of 0.5M NaOH | 273 B.U. |
| Organic Wheat Starch | | 30.9 g of 0.5M HCl | |
| HORG080315-120 g- | 41 ppm | 33.7 g of 0.5M NaOH | 362 B.U. |
| Organic Wheat Starch | | 30.7 g of 0.5M HCl | |

Summary Conclusion for Sodium Hydroxide Method:

The Sodium Hydroxide treatment works best when using 42.06%-56.18% NaOH and 42.06-52.9% HCl, based on dried starch weight, and washed three times to ensure that the chemical and gluten is washed out of the starch, using a starch with an initial ppm of 470 or less.

Acid Trials (HCl)

The first trial with Hydrochloric Acid was performed using both the native wheat starch (60 grams) and Organic Wheat Starch (60 grams) slurried with 90 grams of water, to be combined with 0.5 M HCl, adjusting the pH until it reached 2.5. This solution was allowed to react for 1 hour under stirring at 104° F., washed, then dropped again to 2.5 pH. The solution reacted for another hour under stirring at 104° F., before adjusting the pH to 5.5 using 0.5 M NaOH. This product was then washed three times, to mimic plant conditions, in ridding the sample of agent and the destroyed protein. Below are the gluten results and chemical usage data:

| | FARRP | |
|---|---|---|
| Initial Starch Product | Results-Gluten ppm | Chemical Usage |
| HORG080315-60 g- | 60 ppm | 10.9 g of 0.5M NaOH and |
| Organic Wheat Starch | | 9.8 g of 0.5M HCl |
| H100215-60 g-Native | 65 ppm | 10.6 g of 0.5M NaOH and |
| Wheat Starch | | 9.7 g of 0.5M HCl |

As can be seen, although this treatment effectively reduced gluten levels, it was unsuccessful in reducing gluten levels from as low as 470 ppm to below the 20 ppm threshold.

For acid Trial 2 the following changes:

1. Further the pH drop to 1.8-2.0 pH.

2. All samples will be ran on Organic Wheat Starch.

3. Double the amount of starch was used.

The results were as follows:

| | FARRP | | |
|---|---|---|---|
| Initial Starch | Results-Gluten | | |
| Product | ppm | Chemical Usage | Viscosity |
| HORG080315- | 53 ppm | 39.4 g of NaOH and | 190 B.U. |
| Hydrochloric Acid- | | 41.0 g of HCl | |
| 120 g-pH Drop 1.8-2.0 | | | |

Again, although a significant reduction in gluten content is observed, the threshold 20 ppm was not reached.

Trial 3 for Hydrochloric Acid treated starch was performed with the following changes to procedure:

1. Use Australian Wheat Starch with lower initial gluten ppm (i.e., 38 ppm)

2. Go back to original pH zone of lowering to 2.5.

3. Continue using 120 grams of wheat starch.

| | FARRP | | |
|---|---|---|---|
| Initial Starch | Results-Gluten | | |
| Product | ppm | Chemical Usage | Viscosity |
| N091815-120 g- | 10 ppm | 31.9 g of 0.5M NaOH | 395 B.U. |
| Australian Starch | | 32.6 g of 0.5M HCl | |

These results demonstrate that acid treatment is effective for reduction of gluten level to below the 20 ppm when initial gluten levels are closer to the threshold.

The Hydrochloric Acid treatment works best when the pH is dropped down to 2.5, then washed three times to ensure that the chemical and destroyed gluten is washed out of the starch, using a starch with a relatively low initial gluten content, such as 36 ppm or less.

Surfactant (Sodium Dodecyl Sulfate) Trials

The first trial with Sodium Dodecyl Sulfate was performed using native wheat starch (60 grams) and Organic Wheat Starch (60 grams) slurried with 90 grams of water, to be combined with Sodium Dodecyl Sulfate at 5.5-6.5 pH. This solution was allowed to react for 1 hour under stirring at 104° F., then washed and re-slurried. More Sodium Dodecyl Sulfate was added to the solution, which then reacted for another hour under stirring at 104° F. This product was then washed three times, to mimic plant conditions, in ridding the sample of enzyme and the destroyed protein. Below are the gluten results and chemical usage data:

| | FARRP | |
|---|---|---|
| Initial Starch Product | Results-Gluten ppm | Chemical Usage |
| HORG080315-Organic | 56 ppm | 0.7 g of Sodium Dodecyl |
| Wheat Starch | | Sulfate |
| H100215-Native Wheat | 56 ppm | 0.7 g of Sodium Dodecyl |
| Starch | | Sulfate |

Gluten levels were significantly reduced, but not below the threshold 20 ppm level.

The second trial employed the following changes:

1. Add 50% more SDS.

2. All samples will be ran on Organic Wheat Starch.

3. Double the amount of starch was used.

The results were as follows:

| Initial Starch | FARRP Results- | | |
|---|---|---|---|
| Product | Gluten ppm | Chemical Usage | Viscosity |
| HORG080315- | 23 ppm | 2.24 g of SDS | 380 B.U. |
| 120 g-Organic | | 50% increase of SDS | |
| Wheat Starch | | | |

Again, significant gluten protein reduction was seen, but not below the threshold level.

Trial 3 for Sodium Dodecyl Sulfate treated starch employed further changes:

1. Use Australian Wheat Starch-lower initial gluten ppm.

2. Go back to original amount of SDS.

3. Continue using 120 grams of wheat starch.

The procedures all remained the same as the originals with the above changes.

| Initial Starch | FARRP Results-Gluten | Chemical | |
|---|---|---|---|
| Product | ppm | Usage | Viscosity |
| N091815 Australian | 6 ppm | 1.5 g of SDS | 456 B.U. |
| Starch-SDS | | | |
| Treatment | | | |

The desired threshold levels were reached when starting with a lower initial gluten content.

The Sodium Dodecyl Sulfate treatment works best when using 1.246% SDS or more, then washing three times to ensure that the chemical and protein is washed out of the starch, using a starch with a lower initial gluten content, such as 36 ppm or less.

Sodium Metabisulfite Trials

The first trial with Sodium Metabisulfite was performed using both the native wheat starch (60 grams) and Organic Wheat Starch (60 grams) slurried with 90 grams of water, to be combined with Sodium Metabisulfite 5.5-6.5 pH. This solution was allowed to react for 1 hour under stirring at 104° F., then washed and re-slurried. The solution was treated with more Sodium Metabisulfite, reacted for another hour under stirring at 104° F. This product was then washed three times, to mimic plant conditions, in ridding the sample of enzyme and the destroyed protein. Below are the gluten results and chemical usage data:

| Initial Starch Product | FARRP Results-Gluten ppm | Chemical Usage |
|---|---|---|
| HORG080315-Sodium | 71 ppm | 0.41 g of Sodium |
| Metabisulfite | | Metabisulfite |
| H100215-Sodium | 47 ppm | 0.41 g of Sodium |
| Metabisulfite | | Metabisulfite |

The threshold 20 ppm gluten protein was not reached.

Trial 2 was performed with the following changes:

1. Add 50% more Sodium Metabisulfite.

2. All samples will be ran on Organic Wheat Starch.

3. Double the amount of starch was used.

| Initial Starch | FARRP Results- | | |
|---|---|---|---|
| Product | Gluten ppm | Chemical Usage | Viscosity |
| N091815 Australian | 52 ppm | 0.82 g of Sodium | 202 B.U. |
| Starch-Sodium | | Metabisulfite | |
| Metabisulfite | | | |
| Treatment | | | |

The results were as follows:

| Initial Starch | FARRP Results- | | |
|---|---|---|---|
| Product | Gluten ppm | Chemical Usage | Viscosity |
| HORG080315- | 51 ppm | 1.2 g of Sodium | 151 B.U. |
| Organic Wheat | | Metabisulfite | |
| Starch-120 g | | | |

Trial 3 for Sodium Metabisulfite treated starch employed the following changes to procedure:

1. Use Australian Wheat Starch-lower initial gluten ppm.

2. Go back to original amount of Sodium Metabisulfite.

3. Continue using 120 grams of wheat starch.

Oddly, this trial seemed to increase gluten content. It is believed to be an anomaly, and should be repeated.

Use of Sodium Metabisulfite as the agent was never successful in bringing the gluten ppm down to 20 or less.

Urea Trials

The first trial with Urea was performed using both the native wheat starch (60 grams) and Organic Wheat Starch (60 grams) slurried with 90 grams of water, to be combined with Urea at 5.5-6.5 pH. This solution was allowed to react for 1 hour under stirring at 104° F., then washed and re-slurried. More Urea was added and this solution reacted for another hour under stirring at 104° F. This product was then washed three times, to mimic plant conditions, in ridding the sample of enzyme and the destroyed protein. Below are the gluten results and chemical usage data:

| Initial Starch Product | FARRP Results-Gluten ppm | Chemical Usage |
|---|---|---|
| HORG080315-Urea | 56 ppm | 0.7 g of Urea |
| H100215-Urea | 62 ppm | 0.7 g of Urea |

Trial 2 was performed to implement the following changes to the Urea method:

1. Add 50% more Urea.

2. All samples will be ran on Organic Wheat Starch.

3. Double the amount of Starch was used.

The results were as follows:

| | FARRP Results- | | |
|---|---|---|---|
| Product | Gluten ppm | Chemical Usage | Viscosity |
| HORG080315- | 23 ppm | 2.2 g of Urea | 380 B.U. |
| Urea-120 g-50% | | | |
| more Urea | | | |

Gluten content was significantly reduced, but not to below the threshold level.

Trial 3 for Urea treated starch explored further changes:

1. Use Australian Wheat Starch-lower initial gluten ppm

2. Go back to original amount of Urea.

3. Continue using 120 grams of wheat starch.

The Procedures all remained the same as the originals with the above changes.

| | FARRP Results-Gluten | Chemical | |
|---|---|---|---|
| Product | ppm | Usage | Viscosity |
| N091815 Australian | 22 ppm | 1.5 g of Urea | 456 B.U. |
| Starch | | | |

The Urea treatment was never successful in bringing the gluten ppm down to 20 or less.

Through the above-described lab trials, it was determined that the following methods, with the following initial gluten ppm and chemical ranges were able to achieve gluten-free standards:

Alcalase Enzyme was successful using any starting material with 470 ppm of gluten or less, along with the Alcalase Enzyme at 0.0022% (of starting dry weight) or more and washed three times.

Sodium Hydroxide method was successful using 42.06%-56.18% NaOH and 42.06-52.9% HCl, based on dried starch weight, and washed three times to ensure that the chemical and gluten is washed out of the starch, using a starch with an initial ppm of 470 or less.

The Hydrochloric Acid treatment was successful when the pH is dropped down to 2.5, then washed three times to ensure that the chemical and destroyed gluten is washed out of the starch, using a starch with an initial ppm of 36 or less.

The Sodium Dodecyl Sulfate treatment is successful when using 1.246% SDS or more, then washing three times to ensure that the chemical and destroyed protein is washed out of the starch, using a starch with an initial ppm of 36 or less.

In all of these trials, the viscosity of the product was within range of desired specifications and customer expectations in today's commercial applications.

Treatments using MaxiPro PSP, Urea, and Sodium Metabisulfite were unable to reduce the gluten content to desired levels. Further testing is required to establish whether these agents could be useful under different reaction conditions. The unsuccessful nature of the tests employing these agents demonstrates that finding an appropriate agent, and reaction conditions are unpredictable.

On the strength of the lab trials described above, full plant sized trials were performed as described below.

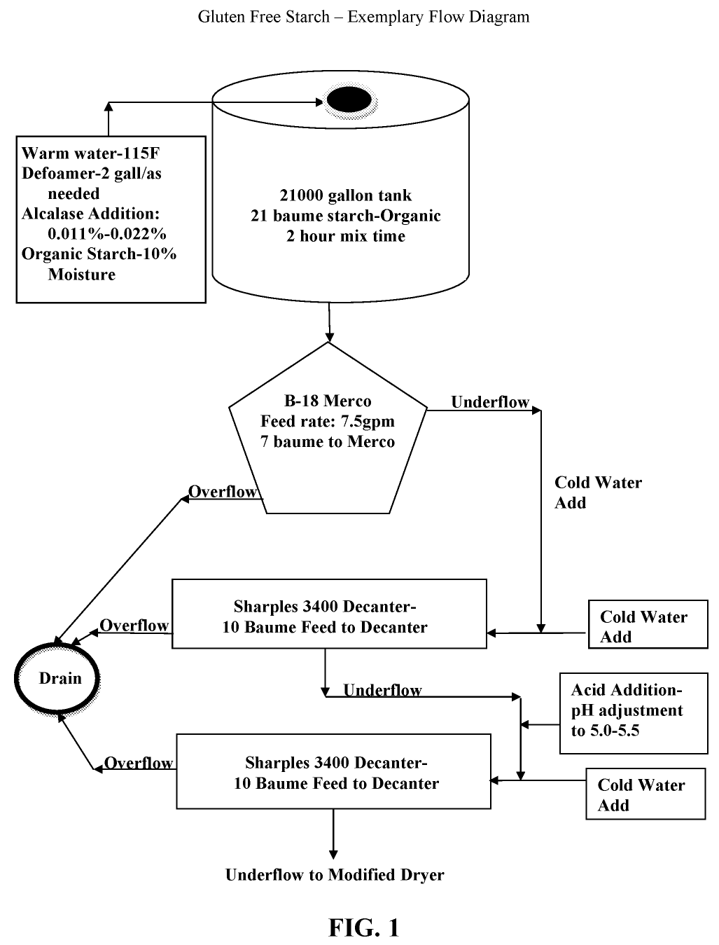

A plant trial was initiated and performed using the Alcalase method with the original amount of Alcalase, 0.022% per dry starch weight. The following procedure and flow chart outline of FIG. 1 illustrate the plant trial parameters.

Alcalase Method Procedure:

1. Slurry in a tank, 22,000 pounds of 10 percent moisture starch with (19,800 dry starch weight) with 1585 gallons of 110° F. water.

2. Maintain a temperature in the slurry at 104° F.

3. Add 4.36 pounds of Alcalase Enzyme (to the top of the tank slowly.)

4. Allow batch to reticulate and stir for 2 hours.

5. At the end of two hours, set the system up to wash through the Merco and 2 decanters adding fresh water to rinse out the residual enzyme and degraded gluten.

6. Adjust the pH after the second wash step and before the third wash step using sulfuric acid to 5.5 pH.

7. Dry the product, discard the first tote as changeover.

8. Sample 4 totes of the 8 totes produced: Totes Sampled: 1, 2, 4, and 7.

9. Send samples out for gluten ppm testing to FARRP Labs.

10. Test starch for residual enzyme activity.

| | R-Biopharm | R-BIOPHARM | |
|---|---|---|---|
| Tote | RIDASCREEN- | competitive | |
| Identification | FARRP | FARRP | Enzyme activity |
| Tote 1 | BLQ | BLQ | Yes |
| Tote 2 | 5 ppm | 11 ppm | No |
| Tote 4 | BLQ | 11 ppm | Yes |
| Tote 7 | BLQ | BLQ | Yes |

The above shows that the desired gluten content below 20 ppm is possible in starch. Future research will focus on better washing techniques to remove residual enzyme.

In light of the success of the lab trials described above, plant scale testing was conducted.

Plant Trial—Gluten-Free Starch Using Alcalase

A plant trial for the production of gluten-free starch using 10,000 pounds of organic starch HORG040716, combined with the Alcalase Enzyme (1.48 pounds or 0.0165%), was set up to prove that the conditions and results at the plant level will match the results obtained from the laboratory trials.

The plant trial consisted of two parts, the first part was done using the starch slurry and 0.0165% Alcalase Enzyme to destroy the gluten. After this was done, it was washed three times to remove the hydrolyzed protein and remaining enzyme. The second part of the plant trial used the remainder of the slurry (about 5000 pounds of dry solids), and treated with Sodium Hydroxide in an attempt to deactivate the enzyme before washing. It was anticipated that by using the Sodium Hydroxide, it would be possible to wash off all the gluten fragments, and deactivate the enzyme.

The process in summary was conducted in the following steps:

PART I—4000 pounds—GFS-A

1. Slurry the 10,000 of starch (9,000 dry weight) in the slurry tank with water at 104° F., until the specific gravity is 20-21 Baumé (approximately 40% solids).

2. Add 1.48 pounds of Alcalase Enzyme to the slurry slowly.

3. Allow the slurry and enzyme to mix for two hours. At the end of the two hours the slurry wash then washed three times (once on a Merco washer and two washes on decanters), before sending it to the dryer to be dried. NOTE: pH was adjusted after second wash to 5.5 using Sulfuric Acid.

4. After these steps, Sodium Hydroxide was added as described in part two.

Part II—4000 pounds—GFS-ACS

1. Adjust the pH of the remaining slurry to 11, using Sodium Hydroxide (this is in an attempt to deactivate the Alcalase Enzyme and wash it out in the washing process).

2. After the pH has been adjusted, wash the slurry three times (once on a Merco washer and two washes on decanters), before drying it on a flash dryer. NOTE: pH was adjusted after second wash to 5.5 using Sulfuric Acid.

Results and summary of the plant trial:

The plant trial results were in direct comparison with laboratory results that we had obtained previously. When the Alcalase Enzyme was introduced to the starch slurry, allowed to react for two hours, and then triple washed before drying, we were able to make a product that tested gluten-free (below 20 ppm) and that was free of any residual enzyme after the third wash. Part 2 of the trial, using Sodium Hydroxide to deactivate the enzyme, still produced a gluten-free starch with no enzyme activity.

The process was successful in at least three key areas that matched up with laboratory results:

1. Both steps did not affect the functionality of the starch.

2. Both procedures, gave a finished product that was free of the Alcalase Enzyme.

3. Both procedures gave a finished product that qualified as gluten-free (less than 20 ppm) using (through FARRP Labs outside laboratory):
a. Test: R-Biopharm: BLQ=below 5 ppm
b. Test: R-Biopharm Competitive Gliadin: BLQ=below 10 ppm

| | Gluten | | | | | |
|---|---|---|---|---|---|---|
| | ppm | Mois- | | | | Enzyme |
| Sample ID | FARRP | ture | Viscosity | Ash | pH | Activity |
| Part 1 GFS-A | BLQ* | 10.61 | 282 B.U. | .19 | 6.78 | None |
| Part 2-GFS ACS | BLQ | 10.89 | 309 B.U. | .21 | 7.02 | None |

*BLQ: Below the limit of quantization. The lower limit of quantization for the R-Biopharm RIDASCREEN Gliadin competitive assay (SOP-BGP-421) is 10 parts per million (ppm) gluten. Amounts below this level cannot be reliably tested in this assay. The R-Biopharm RIDASCREEN Gliadin competitive assay is equally cross-reactive with gliadin/gluten for wheat, rye, and barley. One ppm is equal to one milligram per kilogram of sample product.

If gluten had been detected in this sample at the lower limit of quantization of 10 ppm gluten, the FARRP laboratory estimated measurement of uncertainty for the R-Biopharm RIDASCREEN Gliadin competitive assay would have been 5 ppm. This uncertainty represents an expanded uncertainty expressed at 95% confidence level (using a coverage factor of k=2).

The above methods are applicable to any starch that potentially is contaminated with wheat gluten. As noted above, the non-wheat starches such as corn starch, oat starch, rice starch, tapioca starch, mung bean starch, potato starch, or high amylose starch are amenable to the processes described herein. These starches, when treated similarly to the above-described methods, result in substantially gluten-free starches without introducing functional defects, allowing the starches to be used in products labeled as gluten-free, and where allowed, certified as gluten-free. The table below shows some starting properties of non-wheat starches.

| Starch Type | Moisture | pH | Viscosity | Ash | Gluten ppm |
|---|---|---|---|---|---|
| Corn Starch | 10.22 | 6.39 | 620 | 0.31 | BLQ |
| Waxy Starch | 9.56 | 6.11 | 1506 | 0.28 | BLQ |
| Potato Starch | 9.14 | 6.05 | 3168 | 0.25 | BLQ |
| Tapioca Starch | 9.01 | 5.98 | 1489 | 0.23 | BLQ |

Although non-wheat starches show gluten-free levels, it is known from experience, that from time to time, non-wheat starches are contaminated with cross-over wheat gluten due to being processed in the same plants or farms. Thus, although these starches are naturally gluten-free as shown above, to avoid any uncertainty, these starches could regularly be treated similarly in accordance with the methods described herein. In some instances, because of the relatively low gluten contaminant concentration, methods described herein that might not achieve the less than 20 ppm gluten standard could be useful in removing the relatively low contaminant levels.

Any of the above methods of reducing gluten content may be employed prior to the methods for rendering the starch resistant to α-amylase and thus increase the total dietary fiber.

To achieve the increase in total dietary fiber, the now gluten-free starches are chemically modified to make them resistant to α-amylase.

The chemically modified starches are prepared by reacting a starting starch, here the gluten-free starch, or a slurry containing the gluten-free starch and degraded gluten, in the presence of water and with a cross-linking agent under conditions of pH and temperature to yield a modified starch having the aforementioned α-amylase resistance.

One preparation method involves initially reacting the slurry of the gluten-free starch in water and adding the cross-linking agent to the slurry. The slurry would typically have from about 15-60% by weight starch, and more preferably from about 30-50% by weight thereof. The preferred cross-linker is STMP, TPP, or a mixture thereof. Phosphoryl chloride may optionally be added at least 2.3% by weight. Reaction conditions include a basic pH (preferably from about 10-13 and more preferably from about 11-12) and a reaction temperature of from about 25° C. to about 70° C. and more preferably from about 30° C. to about 50° C. The reaction need be carried out only for a sufficient time to provide the requisite degree of α-amylase resistance typically for a period of from about 10 minutes to 24 hours. In some instances, from about 1-3 hours. An amount (from about 0.1-20% by weight, based upon the weight of the starting starch taken as 100% by weight) of sodium sulfate or sodium chloride may optionally be added to the slurry. The presence of one of these salts serves to retard gel formation during the reaction and to accelerate the reaction by increasing the base adsorbed by the starch granules.

This treatment provides chemically modified starches exhibiting at least about a 15% resistance to α-amylase digestion, as measured using American Association of Analytical Chemists (AOAC) Method 992.16 (1995). More preferably, the starches have at least about 35% resistance, and most preferably at least about 50% resistance to α-amylase digestion using the foregoing method. This corresponds to greater than about 85% total dietary fiber. A wide variety of native starches can be used in the preparation of the chemically modified starches of the invention, for example, starches taken from the group consisting of the cereal, root, tuber, legume starches, high amylose starches, wheat starch, corn starch, oat starch, rice starch, tapioca starch, mung bean starch, and potato starches.

The preferred starches are cross-linked, although acetyl, succinyl, and phosphoryl groups to increase α-amylase digestion resistance.

Lab and Plant Trials—Gluten-Free Resistant Starch

Additional lab testing was conducted using the Protease Method to build upon the examples discussed above and confirm both gluten-free status and resistant nature (>85%TDF) of the modified starch. The starting materials and the method to obtain a gluten-free starch, having less than 20 ppm gluten, and chemicals and their levels to obtain a resistant starch are outlined below:

Starting Material: Organic Wheat Starch HORG041516.

Gluten-free Treatment: Alcalase Enzyme 0.011%-0.022%.

Chemicals and Levels: Sodium Sulfate-5-10%, Sodium TriMetaPhosphate—6-11%, Caustic-treatment pH 9-13, Sulfuric Acid-final pH 5-6.

Through a few laboratory trials, these chemicals, enzymes, and starting materials were settled upon to achieve a gluten-free, resistant labeling. Outside testing for gluten-free status was performed by FARRP Labs-University of Nebraska-Lincoln-Room 276 Food Innovation Center, 1901 N. 21 Street, Lincoln, Nebraska 68588, using the R-Biopharm RIDASCREEN® Gliadin Competitive Assay. Outside testing for the total dietary fiber method AOAC991.43 was done by Medallion Labs (lab trial only) and Midwest Laboratories (plant trial only). Total Phosphates method QA09X-1 was performed by Medallion Labs. In house testing, performed for viscosity and enzyme activity, was completed by a Manildra Quality employee.

Lab Trial

Using Organic Wheat Starch HORG041516 as the starting material, a 36% solids, (396 g of 10% moisture starch combined with 604 g of water) slurry was created and treated with 0.0165% Alcalase (based on dry solids). This solution was then allowed to mix for one hour at 104° F. At the end of the hour, treatment to produce a resistant starch out of the now, gluten-free starch began. The start of the chemical addition began with mixing together sodium sulfate at 8%, based on dry solids, and Sodium TriMetaPhosphate (STMP) at 9%, based on dry solids, then adding that mixture slowly to the slurry. When all of the mixture had been added, it was mixed for 30 minutes to ensure that all chemical was able to mix thoroughly with the starch slurry. At the end of 30 minutes, the slurry was then treated with Sodium Hydroxide to a pH of 11.21 while being heated to 115° F. This slurry was then maintained at 115° F. for 12 hours and a pH above 11. At the end of the 12 hours, the starch slurry was treated with sulfuric acid to adjust the pH to 5.0-6.0 (5.99 adjusted). After the adjustment of the pH, the starch slurry was then washed and decanted three times before drying. After drying, the sample was ground and sent to outside laboratories. Medallion Labs for TDF and phosphate results, and FARRP Labs for gluten ppm analysis. The sample was also tested for enzyme activity by Manildra's in house lab.

Results were as follows:

Chemical Usage

| Chemical | % | Grams |
|---|---|---|
| Sodium Hydroxide-10% | NA | 90.7 g |
| Sulfuric Acid 2.4M | NA | 115.2 g |
| Sodium Sulfate | 8.0% | 28.8 g |
| Sodium TrimMetaPhosphate | 9.0% | 32.4 g |

Physical Data

| | Viscosity | Residual Enzyme |
|---|---|---|
| Sample | (b.u. brabender units) | Activity |
| Organic Starch-H041516 | 404 b.u. | NA |
| (Brabender Chart 1) (Before | | |
| treatment) | | |
| GFRS H041816 | 0 b.u. | No |
| (Brabender Chart 2) (After | | |
| treatment) | | |

| | | | Gluten | |
|---|---|---|---|---|
| | | | ppm-R-Biopharm | |
| | TDF- | | RIDASCREEN ® | Residual |
| | AOAC | Phosphate- | Gliadin | Enzyme |
| Sample | 991.43** | QA09X-1** | Competitive Assay** | Activity |
| GFRS- | 97.0% | <0.1% or | BLQ* below 10 ppm | NONE |
| H041816- | | <1000 ppm | | |
| Lab Trial | | | | |

Thus, the modified starch, GFRS-H041816 is gluten-free, below the level of quantification, in fact, and has high total dietary fiber at 97%. Testing then continued on a plant-size scale to reassess commercial viability.

Plant Trial—Gluten-Free Resistant Starch

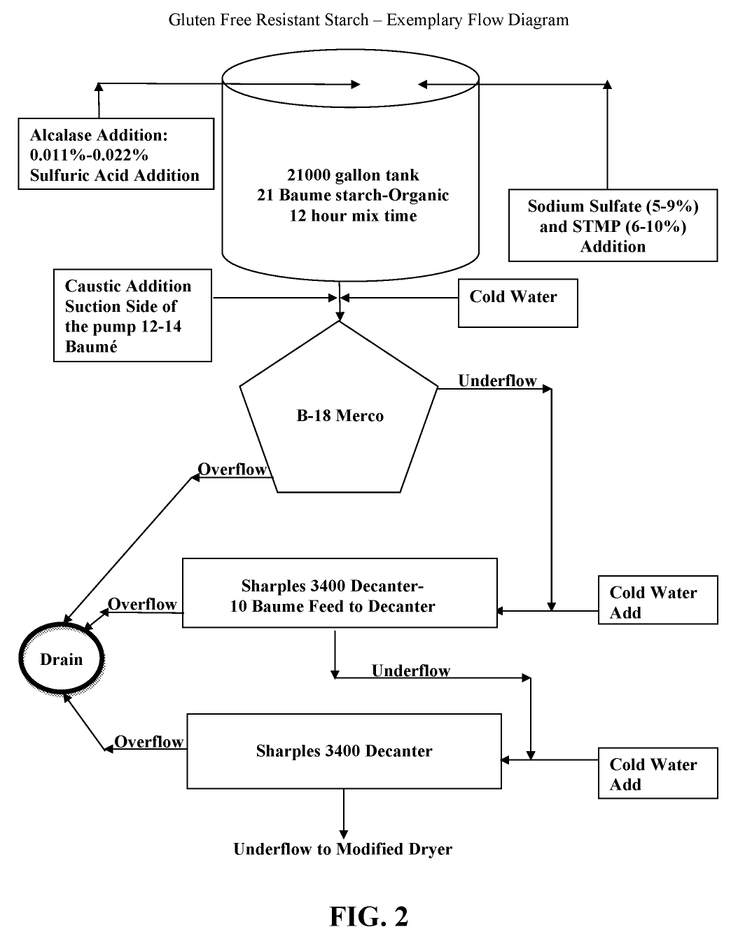

FIG. 2 is a flowchart depicting the process flow and parameters used during the plant trial. Using Organic Wheat Starch (H081616) as the starting material, a 20 Baumé slurry was put into the modified tank and treated with 0.0165% Alcalase (based on dry solids). This solution was then allowed to mix for a half hour at 106.2° F. At the end of the half hour, treatment to produce a resistant starch was started. The start of the chemical addition began with mixing together sodium sulfate at 7.25%, based on dry solids, and Sodium TriMetaPhosphate (STMP) at 8%, based on dry solids, then adding that mixture slowly to the slurry.

After all the STMP and Sodium Sulfate was added, we waited 30-45 minutes, ensuring that all chemical was able to mix thoroughly with the starch slurry. At the end of 30-45 minutes, the slurry was then treated with Sodium Hydroxide, added at 2.0-3.0 gallons per minute and 12-14 Baumé, to a pH of 11.38. This slurry maintained a temperature of 110° F.-115° F. for 12 hours and a pH above 11. At the end of the 12 hours, the starch slurry was treated with 80 gallons of sulfuric acid to adjust the pH to 5.0-6.0 (5.66 adjusted). After the adjustment of the pH, the starch slurry was then washed and decanted three times before drying on the Modified Flash dryer. During drying, the dried product was sent to the packaging system and packed into 50 pound bags. Samples were taken after the 10th and 200th bags packed (out of 346 bags total produced and packed) and shipped to Medallion Labs for TDF and phosphate results, Midwest Laboratories for TDF results, and FARRP Labs for gluten ppm analysis. The sample was also tested for enzyme activity and viscosity by our in house lab.

Trial Data:

Chemical Usage

| Chemical | % | Pounds/Gallons |
|---|---|---|
| Sodium Hydroxide 50% solution | NA | 118.8 gallons |
| Sulfuric Acid-35% solution | NA | 80 gallons |
| Sodium Sulfate | 7.25% | 1700 pounds |
| Sodium TrimMetaPhosphate | 8.00% | 1900 pounds |

Sample Identification

Sample 1 or OGFRS-1 is from bag 10 (start of packaging).

Sample 3 or OGFRS-3 is from bag 200 (end of packaging).

Physical Data Results

Data was compiled in the lab at Hamburg for viscosity and enzyme activity. The results below reflect product that was dried and packaged into 50 pound bags. Starting material was also tested.

| Sample ID | Viscosity | Enzyme Activity |
|---|---|---|
| Org Starch-H081616 | 354 b.u (3rd brabender graph) | NA |
| OGFRS-I | 6 b.u. (4th brabender graph) | None |
| OGFRS-3 | 6 b.u. (5th brabender graph) | None |

Outside Laboratory Results

Samples were prepared and shipped to Midwest Laboratories in Omaha, Nebraska (TDF) and Medallion Labs in Minneapolis (phosphate), and FARRP Labs at UNL (R-Biopharm RIDASCREEN® Gliadin Competitive Assay).

Results were as follows:

| | Midwest | | |
|---|---|---|---|
| | Labs | Medallion Labs | Gluten ppm-R-Biopharm |
| | TDF-AOAC | Total Phosphate- | RIDASCREEN ® Gliadin |
| Sample ID | 991.43** | QA09X-1** | Competitive Assay** |
| OGFRS-1 | 85.4% | <0.1% or | BLQ* |
| H081716 | | <1000 ppm | |
| OGFRS-3 | 85.4% | <0.1% or | BLQ* |
| H081716 | | <1000 ppm | |

Results: The results indicate that the product is a gluten free resistant starch with less than 20 ppm gluten and at least 85% total dietary fiber.

Although the invention has been described with reference to the one or more embodiments illustrated in the figures, it is understood that equivalents may be employed and substitutions made herein without departing from the scope of the invention as recited in the claims.

What is claimed is:

1. A composition comprising:
a chemically-modified starch having at least 85% total dietary fiber; and
less than 20 ppm gluten proteins.

2. The composition of claim 1, wherein the starch is derived from a source naturally containing gluten or a source potentially contaminated with gluten.

3. The composition of claim 1, wherein the chemically-modified star is selected from one or more of wheat starch, rye starch, barley starch, and triticale starch.

4. The composition of claim 1, wherein the chemically-modified starch is at least 15% resistant to α-amylase digestion.

5. The composition of claim 1, wherein at least 95% of the composition is the chemically modified starch.

6. The composition of claim 1, having less than 100 ppm phosphates.

7. A method of making gluten-free resistant starch, the method comprising:
providing an initial starch containing a gluten protein;
mixing the initial starch with water to produce an initial starch slurry;
heating the starch slurry;
adding an agent to dissolve or degrade the gluten protein to yield a slurry containing starch and degraded gluten protein;
mixing sodium sulfate and STMP, with the starch slurry;
raising pH of the slurry to about pH of about 11-13;
increasing heat to 115° F. while maintaining pH 11-13 for 1-24 hours;
reducing pH to 6 by addition of acid;
washing and separating starch from the slurry to yield a purified starch having less than 20 ppm gluten protein, at least 85% total dietary fiber.

8. The method of claim 7, wherein the agent to dissolve or degrade the gluten protein is selected from the group consisting of acids, bases, alcohols, surfactants, proteases, chaotropic agents, reducing agents, and combinations thereof.

9. The method as set forth in claim 7, wherein the agent comprises an acid selected from the group consisting of mineral acids, organic acids and salts thereof, and combinations thereof.

9. The method of claim 7, wherein the agent is Hydrochloric Acid.

10. The method as set forth in claim 7, wherein the agent comprises a base selected from the group consisting of Sodium Hydroxides, potassium hydroxides, calcium hydroxides, ammonium hydroxides, and magnesium hydroxides, and alkaline salts, and combinations thereof

11. The method of claim 10, wherein the base is Sodium Hydroxide.

12. The method according to claim 7, wherein the initial starch containing the gluten protein comprises gluten protein at about 470 ppm or less.

13. The method as set forth in claim 7, wherein the agent comprises an alcohol selected from the group consisting of C₂-C₁₀ alcohols and combinations thereof.

14. The method as set forth in claim 7, wherein the agent comprises a surfactant selected from the group consisting of anionic surfactants, cationic surfactants, nonionic surfactants, and zwitterionic surfactants, and combinations thereof.

15. The method as set forth in claim 7, wherein the agent comprises a protease selected from the group consisting of endo-proteases, exo-proteases, and combinations thereof.

16. The method as set forth in claim 7, wherein the agent comprises Alcalase.

17. The method as set forth in claim 7, wherein the initial starch containing the gluten protein comprises 470 ppm gluten protein or less.

18. The method as set forth in claim 7, wherein the agent comprises the protease Alcalase, and the adding step includes mixing Alcalase with the starch slurry at a pH of about 5.5 to about 6.5.

19. A method of making a gluten-free starch with increased total dietary fiber content, the method comprising:
mixing a gluten-free starch with 8% sodium sulfate and 9% STMP, by weight of the starch;
adding caustic solution to achieve pH 11-13;
increasing heat to 115° F. while maintaining pH 11-13 for 1-24 hours;
reducing pH to 6 by addition of acid;
washing and separating chemically modified starch from solution to yield a purified starch having less than 20 ppm gluten protein, and at least 85% total dietary fiber.
